(19) United States
(12) Patent Application Publication
(10) Pub. No.: US 2011/0247499 A1
(43) Pub. Date: Oct. 13, 2011

(54) IONIZING DEVICE FOR AIR TREATMENT SYSTEMS

(76) Inventor: Manfred H. Langner, Recke (DE)

(21) Appl. No.: 13/140,297

(22) PCT Filed: Dec. 15, 2009
(86) PCT No.: PCT/EP2009/008979

§ 371 Date: Jun. 30, 2011

(30) Foreign Application Priority Data
Dec. 17, 2008 (DE) 10 2008 062 415.2

(51) Int. Cl. B03C 3/38; B03C 3/41

(52) U.S. Cl. 96/54

(57) ABSTRACT

An ionizing device for air treatment systems includes two electrodes that can be connected to a high-voltage source generating an AC voltage and between which a dielectrically encumbered discharge can be induced for generating a plasma, wherein each electrode includes a deformable shape having an electrical conductor encased in a dielectric material and wherein the two deformable shapes are fixed relative to each other such that the two deformable shapes contact each other at least in areas or have a small enough distance from each other that they can induce the dielectrically encumbered discharge.

The invention relates to an ionizing device for air treatment systems with two electrodes, which can be connected to a high-voltage source generating an AC voltage and between which a dielectrically encumbered discharge can be induced to generate a plasma.

Different electrically recoverable devices for cleaning, filtering, or thermally treating air are known. Such devices are used in various ways, for example to make available incoming air which is properly treated, dehumidified, or air-conditioned, or to clean or filter polluted air or free it of airborne particles or smells before release into the atmosphere.

The majority of electrical filter devices known in the trade are electrostatic filters, which can be used advantageously for the capture of dust and other airborne particles. Between the two electrodes a potential difference, i.e., a static electric field, is generated. In an air stream, airborne particles which are carried are ionized in the electrical field, or electrically charged and then activated or captured there by the collecting electrode with the opposite electric potential. The prescribed potential difference must be sufficient to electrically charge and then capture the airborne particles while they are streaming through the filter device. Such an electric filter is often used as a dust collector.

There are other known ionizing devices for air treatment systems and the like, for example, which have two electrodes which are spaced apart and between which a plasma can be generated. Electrodes which are usually structured as flat capacitors are connected to a high voltage source so that a potential difference of more kV can be generated between the electrodes. By application of an appropriate AC voltage, particles situated between the two electrodes and larger molecules are at least partially stimulated or ionized. With an appropriate application of the plasma in this way molecular compounds which are experienced as offensive smells are split into individual components, which are odorless.

Appropriate electrodes fix generating such a plasma are known, for example, from DE 20 2006 014 800.0. Depending on the desired filter or cleaning efficiency, the dimensions of the electrodes must be sufficiently large on the one hand so that they may be driven with an economically practical low AC voltage, of for example, 1 kV-10 kV, and on the other hand so that they may guarantee sufficient ionization of particles contained in the air which is flowing through the plasma. The known electrodes are therefore often extensive and bulky, so that they can he used, for example, in extractor hoods or industrial filter systems, but are not suitable in air filter systems in motor vehicles with limited available space.

A task of the foregoing invention is therefore to structure electrodes of the kind named in the introduction so as to enable comparatively effective generation of a dielectrically encumbered discharge or a plasma with the lowest possible required space.

This task is achieved according to the invention in that each electrode has a deformable shape with an electrical conductor which is encased in dielectric material, both deformable shapes being fixed so that they are in contact in at least in sonic areas, or have a small enough distance from each other that they can induce the dialectically encumbered discharge. The applicant's research has surprisingly shown that fixed flat or lattice-shaped conductors which have been in use up to now and which were seen as a necessary requirement for generating a plasma, are not necessarily essential, and electrodes with deformable shapes can be created, between which a suitable dielectrically encumbered discharge can be induced in order to be able to generate a suitable plasma for air treatment.

Such electrodes, which basically consist of or comprise a deformable shape which is electrically conducive and connectable with a. high voltage source, can be deformed in a simple way and thereby adjusted into various shapes. In this way, the two deformable electrodes which are fixed relative to each other can also be bent, wound or compressed in a random way or at irregular intervals or deformed in almost any way, for example, in order to use to full capacity a prescribed space volume through which the air to be treated flows.

Preferably it is provided that the two deformable shapes each have a linear or filaform profile. Such shapes are simple and inexpensive to produce and make possible deformation into almost any shape, given the choice of appropriate material and depending on dimensions selected in each individual case, without damaging the deformable shape or having to fear an adverse effect on the function of the electrode.

According to a particularly preferable embodiment of the invention it is provided that each electrode has an encased conductor that is plastically deformable. Such conductors encased in an appropriate dielectric material are commercially available and inexpensive. By taking advantage of the plastic properties, the encased conductors can be connected to each other or fixed, for example, crossing each other or wrapped around each other, without major expense or additional measures, so as to achieve a satisfactory stability, in order to guarantee sustained generation of the desired or necessary plasma given the operating conditions and in the above-mentioned shaping.

According to a particularly simple and cost-effective embodiment of the invention it is provided that the two deformable. shapes are interwoven with each other. The preferably filaform deformable shapes can be interwoven with each other this way using known weaving techniques and form a knit or a mesh with approximately textile mechanical properties. The electrodes interwoven with each other display a great number of points of intersection disposed at a distance from each other, to which both deformable shapes can contact. By applying a suitable AC voltage, a potential difference is created between the two electrodes, so that a plasma is generated on the crossing points and in their immediate vicinity, which ionizes particles of the air stream flowing through this area and decomposes large molecules, particles or droplets of fluid into smaller elements or odorless components.

Advantageously, the electrodes woven together form a mesh or textile fabric which, if needed, can be multi-layer, complexly curved, or angled or shifted on the edges, and indeed adapted to almost any space body form.

In order to support the target flexibility and deformability of the deformable shape or the electrodes, it is provided that the deformable shapes have a diameter of less than 2 mm. The use of such dimensions, which can amount to clearly less than 1 mm or more than 2 mm depending on the material used, can simultaneously guarantee that a plasma sufficient for the particular air treatment can be generated at intersections or areas of maximum convergence between the deformable shapes.

Preferably it is provided that there is a distance of more than 5 mm, and preferably of more than 10 mm, between each adjacent intersection of the two deformable shapes. Specification of aperture size can ensure that an air stream flowing through the electrodes can also flow through the electrode arrangement given a multilayer arrangement of the electrode mesh, without generating excessive flow resistance and inappropriately damaging the specified or targeted flow conduction.

It has been shown that it is advantageous for the dielectric material to be a low-carbon material, particularly with regard to the desired long lifespan of the electrodes, despite the stress by the plasma generated. With a dielectric material which has carbon atoms in greater quantity, the individual carbon atoms are detached from the compound, and the dielectric material is damaged. and in time completely destroyed. The danger appears, for example, with the use of a mineral ceramic material, or, not to an equal extent, with the use of a silicone resin.

An example of the embodiment of the inventive thought, shown in the drawing, will be explained next.

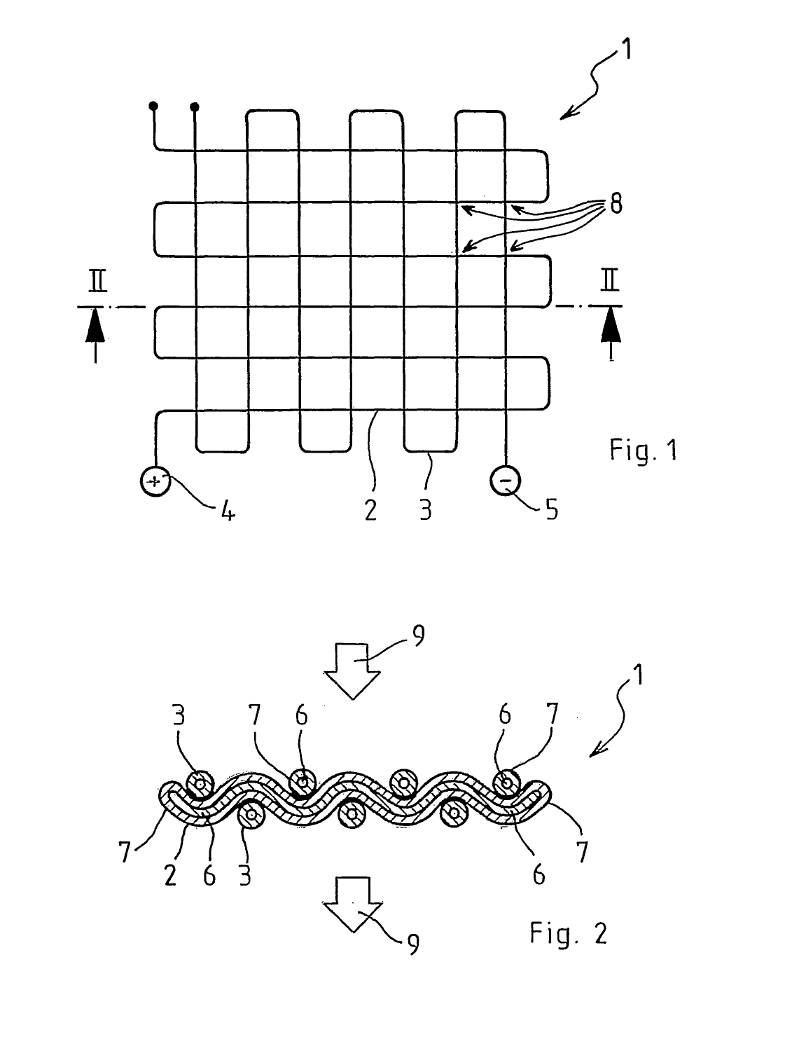

FIG. 1 shows a schematic top view of an electrode arrangement for the generation of a dielectrically encumbered discharge or a plasma, with two filaform deformable shapes, each of which is connected to a high voltage source generating an AC voltage and

FIG. 2 shows a sectional view of the electrode arrangement shown in FIG. 1 along the line II-II in FIG. 1.

The ionizing device 1 for air treatment systems which is shown in the figures has two filaform deformable shapes 2, 3, which are connected to an outlet 4, 5 of a high voltage source, which can generate an AC voltage with an output voltage in the area of, for example, 1 to 10 kV with a prescribed frequency in the range of between one Hertz and a few kilohertz or more.

Both deformable shapes 2, 3 each comprise or consist of an electrically conductive metal filament 6, which is encased with a low-carbon dielectric material 7 or completely insulated. The diameter of the metal filament 6 should measure 1-2 mm. The thickness of the casing with dielectric material 7 should measure less than 1 mm. Both filaform deformable shapes 2, 3, which each form an electrode, are woven together and form a mesh or a textile fabric with fabric-like characteristics. A plasma which can decompose particles, fluid droplets and larger molecules carried along in the air stream into individual constituent parts and components which are odorless and can be harmlessly released into the environment is generated at the points of intersection 8, particularly of deformable shapes 2 and 3, which are in contact lying directly on top of each other, by applying, an appropriate AC voltage. Studies have shown that such an electrode arrangement is suitable advantageously for decomposing volatile organic compounds (VOCs) into individual components that are harmless to the environment.

If the air stream moving in the direction of the arrow 9 flows through the mesh shown in the figures as an example, maximum ionization on the separated points of intersection 8 and on the areas directly surrounding the points of intersection 8 will be achieved. if the separation distance of individual points of intersection 8, and thereby the aperture size of the mesh, is chosen taking into consideration the lowest possible adverse effect on the air stream, so that it is big enough that larger areas in which no plasma is generated remain between the individual points of intersection 8, the ionizing device can have advantageously a multilayer mesh disposed in the direction of flow, and an adequate filtering and cleansing effect can be achieved by repeated entrance of the air stream through mesh layers disposed at a distance from each other.

Other advantages of the arrangement of the electrodes according to the invention include the possibility of keeping these electrodes safe during, operation, or of being able to bring these electrodes into contact with fluids.

1. The invention relates to an ionizing device for air treatment systems with two electrodes, which can be connected to a high-voltage source generating an AC voltage and between which a dielectrically encumbered discharge can be induced, to generate a plasma, wherein each electrode has a deformable shape with an electrical conductor which is encased in dielectric material, both deformable shapes being fixed so that they are in contact in at least in some areas, or have a small enough distance from each other that they can induce the dialectically encumbered discharge.

2. Ionizing device according to claim 1, wherein the two deformable shapes both have a linear or filaform profile.

3. Ionizing device according to claim 1, wherein each electrode has an encased metal filament, which is plastically deformable.

4. ionizing device according to claim 2, wherein the two deformable shapes are interwoven with each other.

5. Ionizing device according to claim 1, wherein the deformable shapes have a diameter of less than 2 mm.

6. Ionizing device according to claim 1, wherein each adjacent intersection of the two deformable shapes has a distance of more than 5 mm, and preferably of more than 10 mm.

7. Ionizing device according to claim 1, wherein the dielectric material is a low-carbon material.

8. Ionizing device according to claim 2, wherein each electrode has an encased metal filament, which is plastically deformable.

9. Ionizing device according to claim 3, wherein the two deformable shapes are interwoven with each other.

10. Ionizing device according to claim 2, wherein the deformable shapes have a diameter of less than 2 mm.

11. Ionizing device according to claim 2, wherein each adjacent intersection of the two deformable shapes has a distance of more than 5 mm, and preferably of more than 10 mm.

12. Ionizing device according to claim 2, wherein the dielectric material is a low-carbon material.
